(19) United States
(12) Patent Application Publication
(10) Pub. No.: US 2015/0292617 A1
(43) Pub. Date: Oct. 15, 2015

(54) CONTROL MECHANISM FOR A CONTINUOUSLY VARIABLE TRANSMISSION

(71) Applicant: AGCO INTERNATIONAL GMBH, Neuhausen am Rheinfall (CH)

(72) Inventor: Richard Heindl, Marktoberdorf (DE)

(21) Appl. No.: 14/438,821

(22) PCT Filed: Dec. 23, 2013
(86) PCT No.: PCT/EP2013/077902

§ 371 Date: Apr. 27, 2015

(30) Foreign Application Priority Data
Dec. 21, 2012 (GB) 1223546.1

(51) Int. Cl. F16H 61/423; F16H 61/433; F16H 61/44; F16H 39/10

(52) U.S. Cl. CPC F16H 61/423; F16H 39/10; F16H 61/433; F16H 61/44

(57) ABSTRACT

A control mechanism for a continuously variable transmission, the transmission having a mechanical branch and a hydrostatic branch, the hydrostatic branch having a variable displacement hydraulic pump which drives first and second variable displacement hydraulic motors, the control mechanism controlling an operating angle of the hydraulic pump and motors, the mechanism comprising: an actuator, a pump adjustment means, operable by the actuator, to vary the operating angle of the pump, characterised in that the mechanism further comprises: first and second motor adjustment means, the adjustment means being operable by the actuator to vary the operating angle of the first and second motors, respectively.

The present invention relates to control mechanisms for vehicle transmissions and in particular, but not exclusively, to a control mechanism for a continuously variable transmission for use in agricultural vehicles such as tractors.

The purpose of a vehicle transmission is to allow the engine to operate at an optimal, or close to optimal, speed for any given vehicle ground speed. In a mechanical transmission this is achieved by the provision of a series of gears of varying gear ratios which are selectively engaged depending on the vehicle speed and torque requirement.

However, the gear ratio of each of the mechanical gears is fixed, requiring a break in the delivery of torque as the previous gear is deselected and the new gear engaged. This leads to inefficiency due to the decoupling of the engine and the driven wheels whilst a new gear is selected.

One solution to this problem is to provide a continuously variable transmission which has two branches (one mechanical and one hydrostatic) to transmit torque from the engine to the driven wheels. The mechanical branch uses gears to provide a mechanical drive between the engine and the wheels. The hydrostatic branch uses a hydraulic pump (driven by the engine) to power a hydraulic motor which in turn drives the wheels. By varying the ratio of power transmitted through the mechanical and hydrostatic branches the speed and torque delivered to the driven wheels can be matched to an optimal engine speed whilst maintaining a constant drive between the engine and the driven wheels.

At slower speeds the majority of the power is delivered by the hydraulic branch, whilst the mechanical branch provides the majority of the torque at higher speed.

The hydraulic pump and motor are typically of a bent-axis design, as is well known in the art, although could be of a swashplate design. For the benefit of doubt the term variable displacement pump/motor is taken to include swashplate or bant-axis pump/motors and any other form of hydraulic pump/motor providing variable displacement in order to vary the relationship between mechanical speed/torque and fluid pressure/flow rate.

The operating angle of the motor/pump is typically controlled by a piston which moves under hydraulic pressure. Flow of hydraulic fluid into the piston is controlled by a pilot valve which is itself operated by an actuator in order to initiate the change in operating angle.

It is known to provide a hydrostatic branch with one pump driving two motors. Historically, the bent axes of the two motors have been mechanically connected via a simple one-piece linkage part so that a change in the position of the piston in response to movement of the pilot valve causes a predetermined proportional change in the operating angle of both motors. In such an arrangement both motors are drivingly connected to one transmission output shaft which in turn drives one or more vehicle axles.

However, in the arrangement set out above it is not possible to achieve operating conditions where the first motor is pivoted to provide zero torque delivery while the second motor remains adjustable.

It is an objective of the present invention to at least mitigate one or more of the above problems.

According to the invention there is provided a control mechanism for a continuously variable transmission, the transmission having a mechanical branch and a hydrostatic branch, the hydrostatic branch having a variable displacement hydraulic pump which drives first and second variable displacement hydraulic motors, the control mechanism controlling an operating angle of the hydraulic pump and motors, the mechanism comprising:
an actuator,
a pump adjustment means operable by the actuator, to vary the operating angle of the pump,
characterised in that the mechanism further comprises:
first and second motor adjustment means, the adjustment means being operable by the actuator to vary the operating angle of the first and second motors, respectively.

Advantageously, the provision of a separate adjustment means for each of the motors allows the speed and torque output of the motors to be independently and flexibly controlled. This offers significant advantages in terms of vehicle control and efficiency. For example, different operating angles can be provided for each motor allowing one motor can be pivoted to zero displacement (represented by a pivot angle of 0° or 45°, depending on specification) while the torque output of the other motor remains adjustable. Furthermore, as one motor can be pivoted to zero displacement while the second motor delivers torque, the first motor can be disconnected by a clutch. Accordingly, the control system, and particularly the relationship between the displacement of first and second motor, can be adapted. This allows the transmission system to be readily configured for different applications.

Preferably, the valves are hydraulic valves.

Preferably, the pump, first and second motors, include a hydraulic cylinder which is actuated in response to operation of the respective valves in order to vary the operating angle of each of the pump and motors.

Preferably, the pump valve and first and second motor valves are linear hydraulic valves operable by the actuator to slide between, open, reversed and closed positions.

Preferably, the actuator is a rotary actuator which rotates a pump valve cam and first and second motor valve cams, the cams acting on a pump valve follower and first and second motor valve followers respectively, the followers being connected to respective pump valve and motor valves in order to move the pump and motor valves between the open, reversed and closed positions upon rotation of the actuator.

Preferably, the cam profile of the second motor valve cam differs from that of the first motor valve cam so that the operating angle of the second motor differs from the operating angle of the first motor at a predetermined position or positions of the actuator.

The invention will now be described, by way of example only, and with reference to the following drawings, in which:

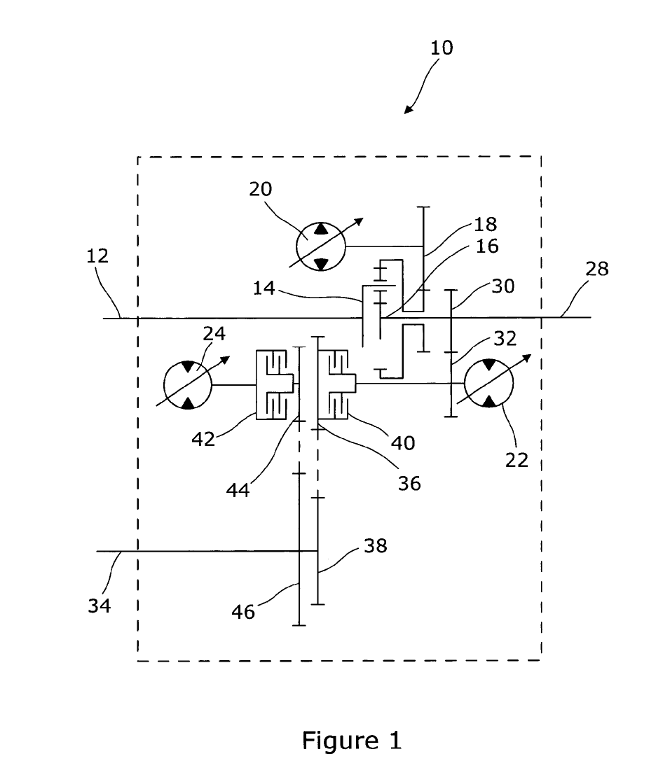

FIG. 1 is a schematic representation of a transmission suitable for use with the control mechanism of the present invention;

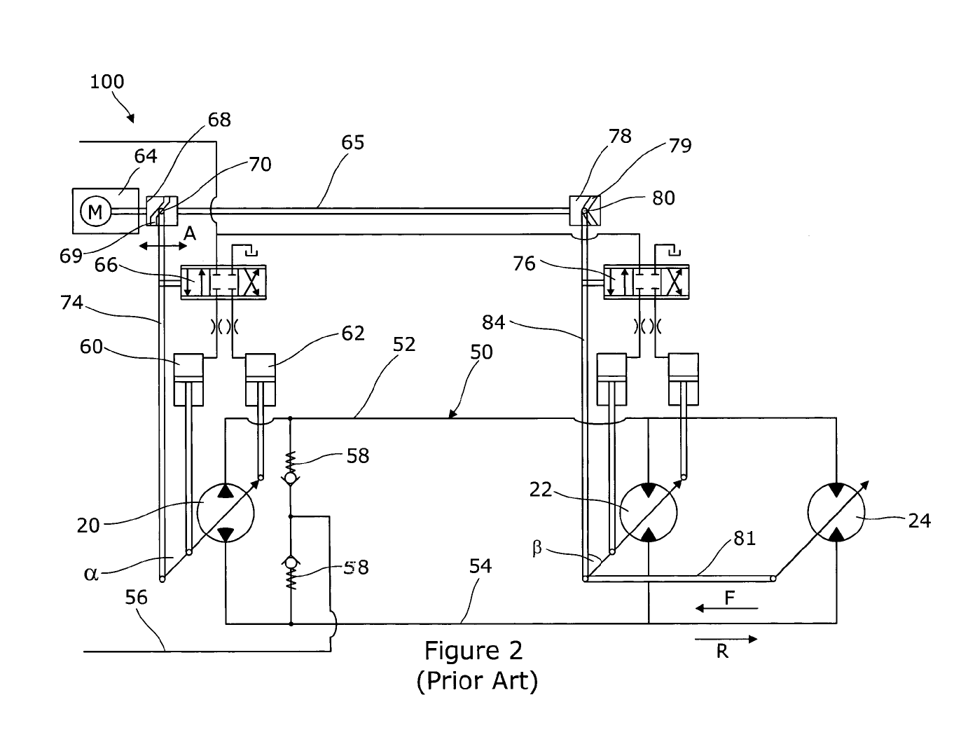

FIG. 2 is a schematic representation of a prior adjustment unit suitable for use with the transmission of FIG. 1; and

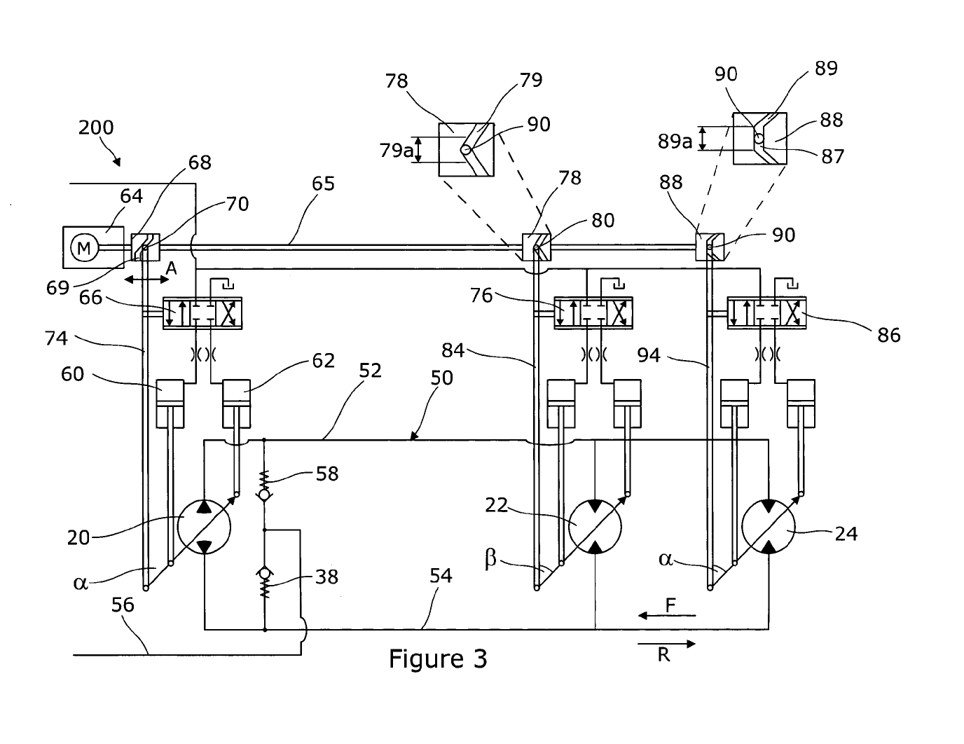

FIG. 3 is a schematic representation of the adjustment unit according the present invention suitable for use with the transmission of FIG. 1.

Referring initially to FIG. 1, a transmission 10 has an input shaft 12 which is driven by a tractor engine, commonly an internal combustion engine (not shown for clarity). The input shaft 12 drives a planetary gear system 14 which splits the input shaft torque between a mechanical branch 16 and a hydraulic branch 18 in a known manner. The hydraulic branch 18 drives a hydraulic pump 20 which provides hydraulic power to first and second hydraulic motors 22, 24 (the hydraulic connection is not shown for clarity).

A rear drive shaft 28 is driven by the first hydraulic motor 22 and the mechanical branch 16 via gears 30, 32. The rear drive shaft 28 drives a rear axle differential which divides torque to the rear wheels (not shown for clarity).

A front axle drive shaft 34 is selectively driven by the first hydraulic motor 22 and mechanical branch 16 of the planetary gear system 14 via gears 36, 38 and clutch 40. The front drive shaft 34 drives a front axle differential which divides torque to the front wheels. The front axle drive shaft 34 is selectively driven by the second hydraulic motor 24 via clutch 42 and gears 44, 46. The clutches 40, 42 can also be engaged to enable the second hydraulic motor 24 to drive the rear drive shaft 26 via the gears 44, 46, 38, 36 and 32.

In this way the first and second motors 22, 24 are able to provide drive to at least the front and rear drive shafts 28, 34 respectively.

The clutch 40 may be disengaged so that first motor 22 is driving rear drive shaft 28 while second motor 24 (presuming that clutch 42 is engaged) is driving front drive shaft 34.

A further possibility may be to install a clutch 40 (of e.g. of friction type) which can be continuously adjusted to adapt the torque transmitted via clutch 40. Thereby the torque delivered by motor 22 to drive rear drive shaft 28 and (via clutch 40) to drive front drive shaft 34 can be adjusted. Second motor 24 (presuming that clutch 42 is engaged) is still driving front drive shaft 34 but is summed up with the torque coming from motor 22 via clutch 40.

Referring now to FIG. 2, a control mechanism for the motors 22, 24 according prior art is shown in the form of adjustment unit 100 of the hydraulic branch 18 of transmission 10.

The hydraulic pump 20, and first and second hydraulic motors 22, 24, are shown in FIG. 2 as axial piston pumps of bent-axis design (also known as oblique-axle design), in which the delivery/intake volume is changed by the pivoting of the axis of rotation of the pistons relative to an output shaft (not shown for clarity) which rotates with the pump chambers in which the pistons move to deliver fluid, as is well known in the art.

The hydraulic pump 20 is connected by fluid circuit 50 to the hydraulic motors 22, 24. The fluid circuit 50 has an upper circuit 52 and a lower circuit 54. The direction of arrow F represents a flow direction of the fluid inside the hydraulic circuit HC during forwards travel of the tractor and the direction of the arrow R represents a flow direction of the fluid during reverse travel of the tractor. In addition a supply line 56 provides oil to compensate oil loses, for example leakage in fluid circuit 50 and pump and motors 20, 22, 24. Flow into the supply line 56 is blocked by check valves 58.

In use, the pump 20 (driven by the input shaft 12 of FIG. 1) pumps hydraulic fluid through the fluid circuit 50 to the motors 22, 24 in order to provide drive to the front and rear axles.

The transmission ratio of the hydraulic branch 18 is controlled by the operating angle of the pump 20 and motors 22, 24. The operating angle is the angle of the axis of rotation of the pistons relative to the bent-axis of the pump chambers and is indicated schematically at a in respect of the pump 20 in FIG. 2.

The pump operating angle α is set by an actuator 64 as follows. The actuator 64 drives a shaft 65 which carries a cam 68. The cam 68 has a groove 69 for receiving a cam follower 70. The follower 70 is attached to a link 74 which moves a valve 66 between open, closed and reversed positions to control the flow of hydraulic fluid into the pistons 60, 62 in order to pivot the pump 20.

In use, the actuator 64 (which is operated by a controller not shown for clarity) rotates the shaft 65 causing the follower 70 to move in the direction of arrow A in order to move the valve 66, via a link 74, between its three positions. Rotation of the actuator 64 thereby allows the operating angle α to be controlled in order to vary the pressure and/or flow rate generated by the pump 20.

The operating angles β of the first motor 22 is controlled in a similar manner to the angle a of the pump 20. The actuator shaft 65 extends to operate a motor cam 78. The cam 78 defines channels 79 which carries follower 80 attached to link 84. The link 84 operates valves 76 in order to control the operating angle β.

Second motor 24 is connected to the first motor 22 via a very simple one-piece linkage part 81 so that a change in the operating angle β of first motor 22 results in a proportional change in the operating angle of second motor 24.

A control mechanism as described above is used in transmissions wherein both motors are drivingly connected to one transmission output shaft which is driving one or more vehicle axles. When used in a transmission according FIG. 1 a major advantage must be considered.

The shown transmission offers the possibility that first motor 22 is driving rear drive shaft 28 (and thereby rear wheels) while second motor 24 is driving front drive shaft 34 (and thereby front wheels). This requires clutch 40 to be disengaged while clutch 42 is engaged. Especially in case of high vehicle speeds, it is advantageous to provide vehicle propulsion only be driving the rear wheels. This can be provided by pivoting the second motor 24 to zero displacement/pivot angle so that torque provided by pump 20 is only driving first motor 22. Ideally, this condition can be provided over a wider range of vehicle speeds, say from 30 km/h to 50 km/h. More preferably, the second motor 24 can also be disconnected from front drive shaft 34 via clutch 42. In this case the second motor 24 is no more driven be the wheels and thereby the losses in the second motor 24 (friction, leakage) are reduced resulting in more efficient operation. The disconnection is only possible if second motor 24 is adjusted to zero displacement, if not, second motor would take all the torque from pump 20 and speed up until destruction as the mechanical resistance is very low. But both, the propulsion of the vehicle only be first motor 22 and the disconnection of the second motor from front drive shaft requires that first motor 22 is pivoted to zero displacement while the displacement of first motor 24 can be adjusted over a certain range.

Referring now to FIG. 3, an advantageous control mechanism for the motors 22, 24 is shown in the form of adjustment unit 200 of the hydraulic branch 18 of transmission 10. The numerals used in respect of adjustment unit 200 of FIG. 2 are used where features are common to both units.

The adjustment unit 200 differs from that shown in FIG. 1 as follows. The actuator shaft 65 of the adjustment unit 200 extends to operate a first motor cam 78 and second motor cam 88. The cams 78, 88 define channels 79, 89 which carry followers 80, 90 attached to links 84, 94. The links 84, 94 operate valves 76, 86 in order to control the operating angles β, γ, whereby angle β is assigned to first motor 22, angle γ is assigned to second motor 24

The profile of the cam channels 69, 79, 89 may differ (as shown by channel 89 including a straight portion 87 not present in channels 69, 79). This allows the operating angle γ of the second motor 24 to differ from that of the first motor 22 for a given position of the actuator 64. Moreover, the operating angle γ of second motor 24 can be kept constant at zero displacement while the operating angle β of first motor 22 varies to deliver a range of torque. This capability is embodied by the straight channel portion 89a which ensures that the follower 90 does not move when the cam 88 pivots in a predetermined range. In contrast the channel portion 79a is curved, inclined or provided with a turning point so that follower 80 moves whenever the cam 78 pivots.

In the embodiment described above, the pump 20 and motors 22, 24 are pivoted indirectly by an electric motor 64 driven a actuator shaft 65, the actuator shaft 65 moving links 74, 84 and 94 to operate valves 66, 76 and 86 which control the flow of oil to the adjust the pivot angles α, β and γ of the respective pump 20 and motors 22, 24.

An alternative approach which falls within the scope of the invention is to operate the valves 66, 76 and 86 by solenoid controlled valves which are directly controlled in order to adjust the pivot angle.

A yet further alternative approach, again within the scope of the invention, is to use an electric motor to directly pivot the pump 20 and motors 22, 24.

Both alternative embodiments would enable both motors 22, 24 to be pivoted completely independently enabling more advanced torque-vectoring.

1. A control mechanism for a continuously variable transmission, the transmission having a mechanical branch and a hydrostatic branch, the hydrostatic branch having a variable displacement hydraulic pump which drives first and second variable displacement hydraulic motors, the control mechanism controlling an operating angle of the hydraulic pump and motors, the mechanism comprising:
an actuator,
a pump adjustment means, operable by the actuator, to vary the operating angle of the pump,
characterised in that the mechanism further comprises:
first and second motor adjustment means, the adjustment means being operable by the actuator to vary the operating angle of the first and second motors, respectively,
wherein each of the pump adjustment means and motor adjustment means are hydraulic valves, and wherein the pump and first and second motors include a hydraulic cylinder which is actuated in response to operation of the respective valves in order to vary the operating angle of each of the pump and motors.

2. (canceled)

3. (canceled)

4. The mechanism of claim 1, wherein the pump valve and first and second motor valves are linear hydraulic valves operable by the actuator to slide between, open, reversed and closed positions.

5. The mechanism of claim 4 wherein the actuator is a rotary actuator which rotates a pump valve cam and first and second motor valve cams, the cams acting on a pump valve follower and first and second motor valve followers respectively, the followers being connected to respective pump valve and motor valves in order to move the pump and motor valves between the open, reversed and closed positions upon rotation of the actuator.

6. The mechanism of claim 5 wherein the cam profile of the second motor valve cam differs from that of the first motor valve cam so that the operating angle of the second motor differs from the operating angle of the first motor at a predetermined position or positions of the actuator.

7. The mechanism of claim 6 wherein the cam profile of the second motor valve cam is designed so that second motor is adjusted to zero displacement while at the same position the first motor valve cam is designed so that first motor provides adjustable torque delivery.

8. The mechanism of claim 6 wherein the cam profile of the second motor valve cam is straight during a predetermined pivoting movement of the rotary actuator while the first motor valve cam is curved.
